(19) United States
(12) Patent Application Publication
(10) Pub. No.: US 2021/0099462 A1
(43) Pub. Date: Apr. 1, 2021

(54) METHODS AND APPARATUS TO IMPROVE PERFORMANCE OF CLOUD-BASED SERVICES ACROSS GEOGRAPHIC REGIONS

(71) Applicant: VMWARE, INC., Palo Alto, CA (US)

(72) Inventors: Tyler J. Curtis, Shingle Springs, CA (US); Robert Benjamin Terrill Collins, Rangiora (NZ); Sufian A. Dar, Bellevue, WA (US); Rachil Chandran, Bangalore (IN); Karthik Seshadri, Bangalore (IN)

(21) Appl. No.: 16/787,056

(22) Filed: Feb. 11, 2020

(30) Foreign Application Priority Data
Sep. 27, 2019 (IN) 201941039117

(51) Int. Cl. H04L 29/06; G06F 16/27

(52) U.S. Cl. CPC H04L 63/107; G06F 16/278; H04L 63/083

(57) ABSTRACT

Methods, apparatus, systems and articles of manufacture are disclosed to improve performance of cloud-based services across geographic regions. An example apparatus includes a response parser to, in response to obtaining an authorization token indicating to utilize a software-as-a-service (SaaS), determine a tenant identification code based on an authorization token, and determine a first point of presence in response to determining the tenant identification code, a shard analyzer to determine a second point of presence of a shard, the shard being a deployed instance of the SaaS, and a shard selector to assign the shard to a user when the first point of presence and the second point of presence are the same.

### RELATED APPLICATIONS

Benefit is claimed under 35 U.S.C. 119(a)-(d) to Foreign Application Serial No. 201941039117 filed in India entitled “METHODS AND APPARATUS TO IMPROVE PERFORMANCE OF CLOUD-BASED SERVICES ACROSS GEOGRAPHIC REGIONS”, on Sep. 27, 2019, by VMware, Inc., which is herein incorporated in its entirety by reference for all purposes.

### FIELD OF THE DISCLOSURE

This disclosure relates generally to cloud computing, and, more particularly, to methods and apparatus to improve performance of cloud-based services across geographic regions.

### BACKGROUND

A user of software and/or a software service often obtains such software and/or a software service in the form of a downloadable licensed software service and/or a licensed software service obtained in a shrink-wrapped format (e.g., packaged on the shelf of a commercial dealer). Alternatively, a user may obtain and/or otherwise utilize software and/or a software service in the form of a Software-as-a-Service (SaaS) model. A SaaS model enables the deployment of SaaS (e.g., software) from a cloud (e.g., a public cloud in the form of web services such as Amazon Web Services (AWS), a private cloud such as a cloud hosted by VMware vSphere™, Microsoft Hyper-V™, etc.)) to a user.

### BRIEF DESCRIPTION OF THE DRAWINGS

FIG. 1 is an illustration of an example environment including an example client device and an example cloud network.

FIG. 2 illustrates the example service network of FIG. 1 to determine assignments in the cloud network of FIG. 1.

FIG. 3 is a flowchart representative of example machine readable instructions which may be executed to implement the cloud network of FIG. 1 to onboard the client device of FIG. 1.

FIG. 4 is a flowchart representative of example machine readable instructions which may be executed to implement the service network of FIGS. 1 and/or 2 to identify an assignment of a user request.

FIG. 5 is a block diagram of an example processor platform structured to execute the instructions of FIGS. 3 and/or 4 to implement the example cloud network of FIG. 1 and/or the example service network of FIGS. 1 and/or 2.

The figures are not to scale. In general, the same reference numbers will be used throughout the drawing(s) and accompanying written description to refer to the same or like parts. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other.

Descriptors “first,” “second,” “third,” etc. are used herein when identifying multiple elements or components which may be referred to separately. Unless otherwise specified or understood based on their context of use, such descriptors are not intended to impute any meaning of priority, physical order or arrangement in a list, or ordering in time but are merely used as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” in such instances, it should be understood that such descriptors are used merely for ease of referencing multiple elements or components.

### DETAILED DESCRIPTION

Traditionally, software and/or a software service is obtained by a user (e.g., a user operating a personal computer (PC), an enterprise operating on a computing infrastructure, etc.) in the form of a downloadable licensed software service, and/or a licensed software service obtained in a shrink-wrapped format (e.g., packaged on the shelf of a commercial dealer). For example, software such as binary files and/or executable files designed for a particular platform of hardware, a particular operating system, etc., are typically made available to customers via a downloadable license and/or a physical storage mechanism (e.g., portable storage mechanism, a Compact Disk (CD), a Universal Serial Bus (USB) flash drive, etc.) sold on the shelf of a commercial retailer. In such typical applications, software and/or a software service is delivered to the user for deployment and/or installation in the user's infrastructure (e.g., a home network PC, a commercial enterprise infrastructure, a datacenter apart of a Wide Area Network (WAN) belonging to the user's organization, etc.).

Alternatively, software and/or a software service may be provided utilizing a Software-as-a-Service (SaaS) model. A SaaS model enables the deployment of SaaS (e.g., software) from a cloud (e.g., a public cloud in the form of web services such as Amazon Web Services (AWS), a private cloud such as a cloud hosted by VMware vSphere™, Microsoft Hyper-V™, etc.)) to a user. In this manner, software and/or SaaS is generated and/or deployed to a common infrastructure accessible by varying tenants of the software. As used herein, a tenant refers to any suitable user (e.g., a personal user, an enterprise system, etc.) accessing and utilizing a SaaS. Furthermore, a SaaS model may be operable on a similar infrastructure as in the downloadable licensed software service and/or a shrink-wrapped licensed software applications.

In operation, a SaaS model and/or a system enables a user to access the software and/or otherwise SaaS from a cloud (e.g., a public cloud web service such as Amazon Web Services (AWS), a private cloud such as a cloud hosted by VMware vSphere™, Microsoft Hyper-V™, etc.)). In this manner, the provider of the SaaS typically handles installation, deployment, and/or maintenance of the corresponding infrastructure components (e.g., servers, datacenters, and/or computing devices hosting the SaaS). A user may access the SaaS (e.g., access software to be utilized) via a suitable user interface (UI) and/or Application Program Interface (API) identifiable by Uniform Resource Locators (URLs). As such, a user may then access and use the SaaS over any suitable WAN such as, for example, the World Wide Web over network connectivity.

Operating a SaaS is advantageous for both a user and a provider of the SaaS model. For example, the provider of the SaaS can deliver quick and efficient software updates (e.g., bug fixes, additional features, etc.) to the common infrastructure hosting the SaaS. In this manner, a provider of a SaaS model can deploy a software update for the SaaS to all users accessing the common infrastructure, rather than distributing individual updates to each user in a downloadable licensed form and/or in a licensed shrink-wrap form.

Furthermore, the infrastructure hosting a SaaS is typically located in single geographic region (e.g., a datacenter and/or a server room in the United States of America, etc.). For example, if a SaaS is hosted in the United States of America, users located in Canada communicate with the infrastructure hosting the SaaS (e.g., datacenter and/or server rooms) in the United States of America in order to utilize the SaaS. Such a user located outside the geographic region in which the infrastructure hosting the SaaS is located may experience performance degradation and may be subject to complying with data residency barriers and/or laws. For example, a user located in the United Kingdom may experience higher network latency when utilizing the SaaS than a user located in the United States of America if the infrastructure hosting the SaaS is located in the United States of America. Moreover, a user in a geographic region outside of the geographic region in which the infrastructure hosting the SaaS is located may need to navigate complicated data import and/or export laws (e.g., laws created and/or enforced by governing bodies of the respective geographic regions and/or locations to protect data) in order to utilize the SaaS properly.

Efficient utilization of a SaaS and/or operation of a SaaS model is often dependent on whether the provider of the SaaS properly provisions the infrastructure (e.g., the servers, datacenters, and/or computing devices hosting the SaaS) and/or performs maintenance on the infrastructure (e.g., ensure security standards comply, etc.) to ensure users experience the least network latency possible while maintaining safe and compliant user data (e.g., data transfers that comply with data transfer laws and/or data privacy laws of corresponding geographic regions and/or locations).

Examples disclosed herein improve performance of cloud-based services across geographic regions. Examples disclosed herein utilize infrastructure located in a plurality of geographic regions. As such, examples disclosed herein utilize an infrastructure cluster of computing devices (e.g., server(s), datacenter(s), and/or any suitable computing device(s)) configured to host one or more SaaS service(s).

Examples disclosed herein deploy a service (e.g., a SaaS) to a plurality of infrastructures located in a plurality of geographic regions. In examples disclosed herein, a service (e.g., a SaaS) is a software component in the form of an application or micro-service. A service (e.g., a SaaS) may be deployed as a single instance, or as a plurality of micro-services utilized together. For example, two micro-services may be utilized and deployed as a singular service (e.g., a SaaS). Alternatively, in examples disclosed herein, a service (e.g., a SaaS) may be deployed as a micro-service separate from other micro-services included in the SaaS. In examples disclosed herein, a service (e.g., a SaaS) is identified by a name and/or tag (e.g., service-a, service-b, VMware Hybrid Cloud Platform, VMware Cloud Assembly, VMware Code Stream, etc.).

In examples disclosed herein, a deployed instance of a service (e.g., a SaaS) may be referred to as a shard. A service (e.g., a SaaS) may be deployed into one or more shards (e.g., any suitable number of shards). As such, a shard (e.g., a deployed service and/or SaaS) is utilized in an infrastructure located in a plurality of geographic regions. As used herein, infrastructure refers to any suitable cloud infrastructure, network infrastructure, computing infrastructure, servers, datacenters, etc., configured to host a cloud computing service and/or computing resource. For example, a service (e.g., SaaS) may be separated into two shards deployed in an inter-region infrastructure in two different geographic regions, respectively. Thus, such an example service is readily accessible in both geographic regions. In an alternate example, a service (e.g., a SaaS) may be separated into two shards deployed in an intra-region infrastructure located in a single geographic region. In such an example, the two shards may be assigned a weight indicative of processing power and/or capability (e.g., a number of Central Processing Units (CPUs) available), available memory, etc., for use in later assignment. In examples disclosed herein, a higher weight relative to a lower weight corresponds to a higher availability to operate additional services. For example, if a first shard has a weight of 0.9 and a second shard has a weight of 0.7, the first shard can handle more processing tasks than the second shard (e.g., can handle a user assignment more efficiently than the second shard).

In examples disclosed herein, any suitable number of tenants may be assigned to a shard. Additionally, a shard may be associated with and/or contain attributes such as a name (e.g., service-a-shard, service-a-shard-1, service-b-shard-1, VMware Hybrid Cloud Platform Shard 1, VMware Cloud Assembly Shard 1, VMware Code Stream Shard 1, etc.), a label (e.g., a tag that identifies the shard with attributes utilized to perform various functions in the SaaS, a tag that identifies the weight of the shard, etc.), and/or an address (e.g., a URL, a connection string to a database connection, and/or any suitable information identifying a region to access the shard).

Examples disclosed herein assign a tenant to a shard. More specifically, examples disclosed herein include obtaining a point of presence (PoP) indication from a user and assigning such a user (e.g., a tenant, an assigned user, etc.) to a shard associated with a similar PoP. For example, if a user indicated a PoP of the United Kingdom and would like to utilize a service (e.g., a SaaS), then the user would be assigned a shard that is a deployed instance of the service (e.g., the SaaS) located in the same PoP (e.g., in the United Kingdom). In examples disclosed herein, an assignment represents the relationship between a tenant and a service and/or a deployed instance of a service (e.g., a shard). In examples disclosed herein, a tenant's data may not be persisted, utilized, stored, and/or otherwise accessed outside the indicated PoP. In such an example, data from a tenant located in the United Kingdom may not be accessible (e.g., readable, writable, transmittable, etc.) by tenants located outside the United Kingdom (e.g., Japan, the United States of America, etc.).

Examples disclosed herein improve performance when accessing and/or otherwise utilizing a service (e.g., a SaaS). For example, examples disclosed herein enable a user to be assigned to a shard deployed as a selected service (e.g., a SaaS) in a similar geographic region as the user. Furthermore, examples disclosed herein enable a user in a first region to utilize the SaaS hosted on infrastructure located in a second region while maintaining a similar performance experience as users in the second region. Therefore, examples disclosed herein improve performance of operating a SaaS model while users are accessing, operating, and/or otherwise utilizing a SaaS.

In the event a user a plurality of services (e.g., a first SaaS and a second SaaS), examples disclosed herein enable a user to select a first PoP corresponding to a selected region to run the first SaaS, and a second PoP corresponding to a selected region to run the second SaaS. For example, a user may desire to utilize a first SaaS in the United States of America and a second SaaS in the United Kingdom. Examples disclosed herein enable a user to utilize multiple SaaS deployments in an efficient manner. Such examples disclosed herein are explained in further detail, below.

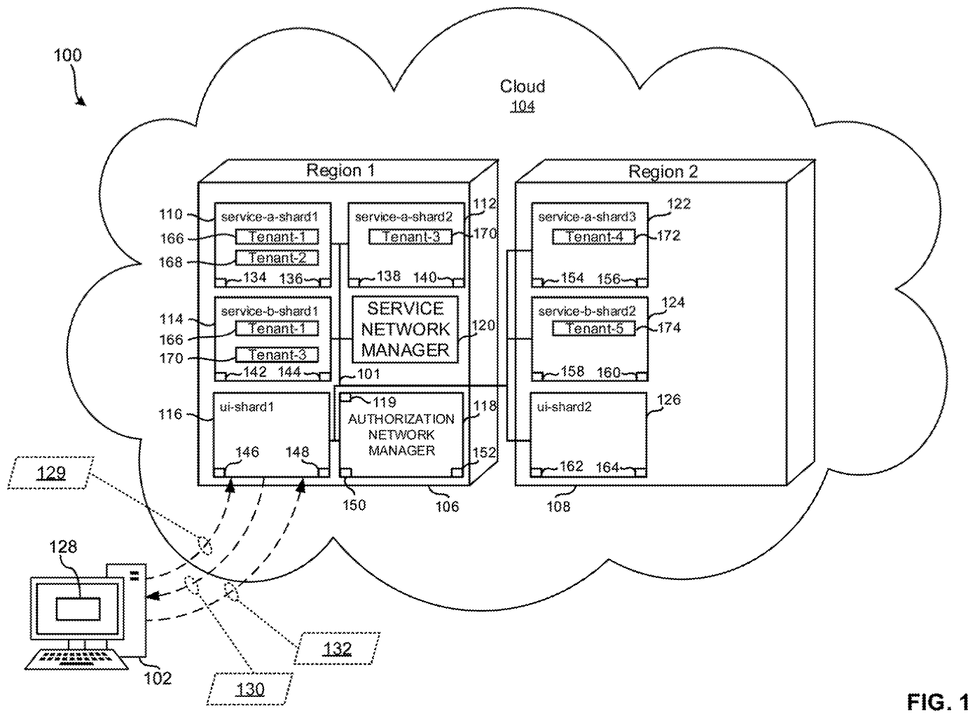

FIG. 1 is an illustration of an example environment 100 including an example client device 102 and an example cloud network 104. In the example environment 100 of FIG. 1, the cloud network 104 includes a first cluster 106 and a second cluster 108. In FIG. 1, the first cluster 106 is located in a first geographic region (Region 1), and includes an example first shard 110, an example second shard 112, an example third shard 114, an example gateway shard 116, an example authorization network manager 118, and an example service network manager 120. In the example of FIG. 1, the first shard 110 and the second shard 112 represent two deployed instances of a first SaaS (e.g., service-a deployed as shard1 and shard2). The third shard 114 represents a deployed instance of a second SaaS (e.g., service-b deployed as shard1). The gateway shard 116 represents a gateway for an example user interface 128 (e.g., ui-shard1) located in Region 1. In some examples disclosed herein, the example gateway shard 116 implements means for transmitting.

In FIG. 1, any of the first shard 110, the second shard 112, the third shard 114, the gateway shard 116, the authorization network manager 118, and/or the service network manager 120 may communicate via an example communication network 101. In examples disclosed herein, the communication network 101 may be implemented by any suitable wired and/or wireless communication method and/or device. In some examples disclosed herein, the example first shard 110 implements first means for servicing. In some examples disclosed herein, the example second shard 112 implements second means for servicing. In some examples disclosed herein, the example third shard 114 implements third means for servicing.

In FIG. 1, the second cluster 108 is located in a second geographic region (Region 2), and includes an example fifth shard 122, an example sixth shard 124, and an example second gateway shard 126. In the example of FIG. 1, the fifth shard 122 represents a third deployed instance of the first SaaS (e.g., service-a deployed as shard3) and the sixth shard 124 represents a second deployed instances of the second SaaS (e.g., service-b deployed as shard2). The second gateway shard 126 represents a second gateway for the user interface 128 (e.g., ui-shard2) located in Region 2. In some examples disclosed herein, the example second gateway shard 126 implements second means for transmitting. In other examples disclosed herein, the first cluster 106 and the second cluster 108 may be included in separate cloud networks.

Furthermore, any of the fifth shard 122, the sixth shard 124, and/or the second gateway shard 126 are configured to communicate with any of the first shard 110, the second shard 112, the third shard 114, the gateway shard 116, the authorization network manager 118, and/or the service network manager 120 via the example communication network 101. In some examples disclosed herein, the example fifth shard 122 implements fifth means for servicing. In some examples disclosed herein, the example sixth shard 124 implements sixth means for servicing.

In the example illustrated in FIG. 1, the client device 102 is illustrated as a personal computer (PC). The client device 102 includes the user interface 128. In operation, a user of the client device 102 transmits an example onboarding request 129 to the gateway shard 116. For example, a user of the client device 102 may transmit the onboarding request 129 to the gateway shard 116 via a HyperText Transfer Protocol (HTTP) request, a URL, or any suitable means of communication. Such an example HTTP request in the onboarding request 129 may include data indicative of a selected SaaS to use.

In FIG. 1, the user interface 128 receives input from the authorization network manager 118 such as an example onboarding link 130. The onboarding link 130 obtained by the authorization network manager 118, when selected and/or otherwise clicked on, prompts a user of the client device 102 to initiate onboarding of a SaaS (e.g., select at least one of the first SaaS or the second SaaS) and/or onboarding of a SaaS selected in the onboarding request 129. In examples disclosed herein, the onboarding link 130 may be an example hyperlink communicated by the authorization network manager 118 in response to the onboarding request 129. As such, the onboarding link 130 may include a URL of a redirect destination server, of a login service, etc. In examples disclosed herein, onboarding of a SaaS (e.g., the first SaaS or the second SaaS) may refer to the selection of a specific SaaS (e.g., the first SaaS or the second SaaS) and/or providing user credentials (e.g., login name, password, etc.) to operate a selected SaaS. Once a user initiates onboarding of a SaaS (e.g., the first SaaS or the second SaaS), an example onboarding reply 132 is sent to the authorization network manager 118. In examples disclosed herein, the onboarding reply 132 includes user-provided information such as a user-selected PoP (e.g., Region 1, Region 2, etc.) and/or a user-selected SaaS to utilize (e.g., the first SaaS or the second SaaS). In examples disclosed herein, the user interface 128 may be implemented by a touchscreen, a keyboard, graphical user interface (GUI), etc. However, any other type of user interface device(s) may additionally or alternatively be used. For example, the example user interface 128 may be implemented by an audio microphone, light emitting diodes, a mouse, a button, etc.

In the example of FIG. 1, the cloud network 104 is implemented using a public cloud network. For example, the cloud network 104 may be implemented using as web service such as Amazon Web Services (AWS). Alternatively, the cloud network 104 may be implemented using any other suitable cloud web service such as, for example, a private cloud hosted by VMware vSphere™, Microsoft Hyper-V™, etc., and/or any suitable combination of public and/or private cloud web services.

In FIG. 1, the example first shard 110 is illustrated as a first deployed instance of the first SaaS (e.g., service-a deployed as shard1). The first shard 110 includes an example label 134 and an example address 136. The example second shard 112 is illustrated as a second deployed instance of the first SaaS (e.g., service-a deployed as shard2). The second shard 112 includes an example label 138 and an example address 140. The example third shard 114 is illustrated as a deployed instance of the second SaaS (e.g., service-b deployed as shard1). The third shard 114 includes an example label 142 and an example address 144. The example gateway shard 116 is illustrated as a gateway for the user interface 128 (e.g., ui-shard1). The gateway shard 116 includes an example label 146 and an example address 148. The authorization network manager 118 includes an example label 150 and an example address 152. In some examples disclosed herein, the service network manager 120 may be referred to as a shard and include an example label and an example address. In some examples disclosed herein, the example service network manager 120 implements means for managing.

The labels 134, 138, 142, 146, and 150 of the first shard 110, the second shard 112, the third shard 114, the gateway shard 116, and the authorization network manager 118, respectively, include data associated with the geographic region (e.g., Region 1) in which the first shard 110, the second shard 112, the third shard 114, the gateway shard 116, and the authorization network manager 118 are deployed, and a corresponding weight. In examples disclosed herein, the weights of the labels 134, 138, 142, 146, and 150 correspond to processing power and/or capability (e.g., a number of Central Processing Units (CPUs) available), available memory, etc., of the first shard 110, the second shard 112, the third shard 114, the gateway shard 116, and the authorization network manager 118, respectively. In example operation, because the first shard 110 and the second shard 112 illustrate two deployed instances of the first SaaS (e.g., service-a deployed as shard1 and shard2, respectively), a user indicating in the onboarding request 129 and/or the onboarding reply 132 to utilize the first service in the first region (e.g., Region 1) may be assigned to either the first shard 110 or the second shard 112. Further in such an example, such a user may be assigned to the shard with the highest weight (e.g., the shard most capable of handling additional processing power). In other examples disclosed herein, a user may be assigned to the shard based on satisfying any other threshold weight (e.g., the lowest weight, etc.) selected for use as a conditional requisite in that geographic region and/or in the cloud network 104.

In the example of FIG. 1, the addresses 136, 140, 144, 148, and 152 of the first shard 110, the second shard 112, the third shard 114, the gateway shard 116, and the authorization network manager 118, respectively, include data corresponding to a connection string utilized to access the shard. In examples disclosed herein, a user may select at least one of the addresses 136, 140, 144, 148, and/or 152 in either the onboarding request 129 and/or the onboarding reply 132 to select a SaaS to use.

In FIG. 1, the example fifth shard 122 is illustrated as a third deployed instance of the first SaaS (e.g., service-a deployed as shard3) in the second geographic region (Region 2). The fifth shard 122 includes an example label 154 and an example address 156. The example sixth shard 124 is illustrated as a second deployed instance of the second SaaS (e.g., service-b deployed as shard2). The sixth shard 124 includes an example label 158 and an example address 160. The example second gateway shard 126 is illustrated as a gateway for the user interface 128 (e.g., ui-shard2) in Region 2. The second gateway shard 126 includes an example label 162 and an example address 164.

The labels 154, 158, and 162 of the fifth shard 122, the sixth shard 124, and the second gateway shard 126, respectively, include data associated with the geographic region in which the fifth shard 122, the sixth shard 124, and the second gateway shard 126 are deployed (e.g., Region 2, the United Kingdom, etc.), and a corresponding weight. In examples disclosed herein, the weight of the labels 154, 158, and 160 correspond to processing power and/or capability (e.g., a number of Central Processing Units (CPUs) available), available memory, etc., of the fifth shard 122, the sixth shard 124, and the second gateway shard 126, respectively. In example operation, because the first shard 110, the second shard 112, and the fifth shard 122 illustrate the deployed instances of the first SaaS across two geographic regions (e.g., service-a deployed as shard1 and shard2 in Region 1 and service-a deployed as shard3 in Region 3, respectively), a user indicating in the onboarding request 129 and/or onboarding reply 132 to utilize the first service in the second region (Region 2) may be assigned the fifth shard 122.

In the example of FIG. 1, the addresses 156, 160, and 164 of the fifth shard 122, the sixth shard 124, and the second gateway shard 126, respectively, include data corresponding to a connection string utilized to access the shard. In examples disclosed herein, a user may select at least one of the addresses 156, 160, and/or 164 in either the onboarding request 129 and/or the onboarding reply 132 to select a SaaS to use.

In an example operation, the authorization network manager 118 is configured to send the onboarding link 130 to the client device 102. Once received, a user of the client device navigates the onboarding link 130 in order to select, enter, and/or otherwise provide a selected PoP and/or SaaS. Additionally a user may provide login information while navigating the onboarding link 130. In response, the authorization network manager 118 determines whether the onboarding reply 132 is received. In the event the authorization network manager 118 determines the onboarding reply 132 is received, the authorization network manager 118 creates a tenant identification code for the user. In addition and/or in parallel, the authorization network manager 118 is configured to initiate a login sequence with and return the created tenant identification code to the client device 102 (e.g., transmit the client identification code to the client device 102 via the gateway shard 116 and/or the communication network 101). In response to execution of a successful login sequence, the authorization network manager 118 generates an example authorization token 119. The authorization network is further configured to transmit the authorization token 119 to the gateway shard 116. In this manner, the gateway shard 116 is configured to transmit the authorization token 119 to the service network manager 120. In some examples disclosed herein, the example authorization network manager 118 implements means for authorizing.

The service network manager 120 of FIG. 1 is implemented by a logic circuit such as, for example, a hardware processor. However, any other type of circuitry may additionally or alternatively be used such as, for example, one or more analog or digital circuit(s), logic circuits, programmable processor(s), application specific integrated circuit(s) (ASIC(s)), programmable logic device(s)(PLD(s)), field programmable logic device(s) (FPLD(s)), digital signal processor(s)(DSP(s)), etc. The service network manager 120 is configured to obtain the authorization token 119 from the gateway shard 116 and/or the authorization network manager 118. Once the authorization token 119 is obtained from the gateway shard 116 and/or authorization network manager 118, the service network manager 120 is configured to parse the authorization token 119 to determine the tenant identification code previously created. In this manner, the service network manager 120 is configured to communicate with the authorization network manager 118 to determine the corresponding PoP of the tenant (e.g., a user of the client device 102). In the event a PoP is not selected by the service network manager 120, the service network manager 120 may select a shard within the current PoP capable of operating the selected SaaS. For example, if a user does not select a PoP, such a shard assignment selected by the service network manager 120 may be generated independent of a PoP preference.

Alternatively, if a PoP is selected, the service network manager 120 is configured to communicate with the first shard 110, the second shard 112, the third shard 114, the gateway shard 116, the authorization network manager 118, the fifth shard 122, the sixth shard 124, and/or the second gateway shard 126 to determine the weight and PoP selected in the respective labels 134, 138, 142, 146, 150, 154, 158, and 162, respectively. Once the labels 134, 138, 142, 146, 150, 154, 158, and 162 have been analyzed to determine corresponding weights and PoPs, the service network manager 120 is configured to assign the user to a shard. In such an example, the assignment makes the user a tenant and/or otherwise an assigned user of the shard.

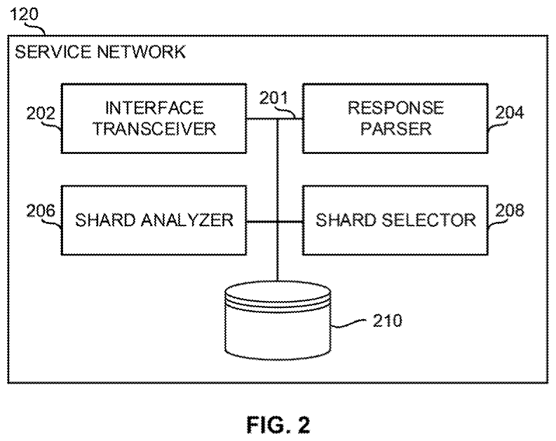

In examples disclosed herein, if a user selects Region 1 and the first SaaS, the service network manager 120 determines which of the first shard 110 or the second shard 112 are most capable of handling the request (e.g., have the most available weight, the highest weight, most available computing resources, etc.) and assigns the user to such a shard. In examples disclosed herein, if a user selects Region 2 and the second SaaS, then the service network manager 120 assigns the user to the sixth shard 124. In examples disclosed herein, the service network manager 120 transmits the assignment to the gateway shard 116. In some examples, a shard to be assigned is located in a different geographic region. In such instance, a redirect may be necessary to provide the user suitable access to a user interface in the same region as the shard. A redirect may be accomplished by transmitting a signal to the gateway shard 116, in which the gateway shard 116 can transfer user data to a gateway located in the location of the selected shard (e.g., the second gateway shard 126). In the event the gateway shard 116 determines a redirect is necessary (e.g., the assignment indicates a shard located outside of Region 1), then the gateway shard 116 transmits and/or otherwise redirects such an assignment to the shard deployed as a user interface in the corresponding PoP. In the example of FIG. 1, users located in a plurality of geographic regions and/or selecting a plurality of PoPs communicate with the gateway shard 116 in the first cluster 106. In the event a user is located in a different geographic region and/or selects a PoP different than the first cluster 106, the user may communicate such information to the gateway shard 116 and, upon assignment by the service network manager 120, is assigned to a corresponding shard in the respective PoP. The service network manager 120 is described in further detail below, in connection with FIGS. 2, 3, and 4.

In the example of FIG. 1, the first shard 110 includes a first tenant 166 and a second tenant 168. The second shard 112 includes a third tenant 170. The fourth shard includes the first tenant 166 and the third tenant 170. The fifth shard 122 includes a fourth tenant 172. The sixth shard 124 includes a fifth tenant 174. While FIG. 1 includes the first tenant 166, the second tenant 168, the third tenant 170, the fourth tenant 172, and the fifth tenant 174, any suitable number of tenants may be included. Moreover, in FIG. 1, the gateway shard 116, the authorization network manager 118, and the second gateway shard 126 include a weight of zero in the respective labels 146, 150, 162. In this manner, the service network manager 120 does not assign a user (e.g., a tenant) to the gateway shard 116, the authorization network manager 118, and the second gateway shard 126 because the weights are zero. In other examples disclosed herein, the gateway shard 116, the authorization network manager 118, and/or the second gateway shard 126 may include a weight in the respective labels 146, 150, 162 to obtain an assignment.

FIG. 2 illustrates the example service network manager 120 of FIG. 1, to determine assignments in the cloud network 104. The service network manager 120, as illustrated in FIG. 2, includes an example interface transceiver 202, an example response parser 204, an example shard analyzer 206, an example shard selector 208, and an example database 210. In FIG. 2, any of the interface transceiver 202, the response parser 204, the shard analyzer 206, the shard selector 208, and/or the database 210 may communicate via an example communication network 201. In examples disclosed herein, the communication network 201 may be implemented by any suitable wired and/or wireless communication network such as, for example, a network of wireless transceivers, a wired ethernet connection (e.g., a registered jack 45 (RJ45) cable), etc.

In the example illustrated in FIG. 2, the interface transceiver 202 is implemented by a WiFi radio that communicates with the gateway shard 116 and/or the authorization network manager 118 of FIG. 1. In examples disclosed herein, any other type of wireless transceiver may additionally or alternatively be used to implement the interface transceiver 202. The interface transceiver 202 is configured to communicate with the gateway shard 116 and/or the authorization network manager 118 of FIG. 1 to obtain the example authorization token 119 of FIG. 1. In examples disclosed herein, the authorization token 119 includes information such as, for example, a tenant identification code, login credentials, a name or identifier of a selected SaaS, etc. In FIG. 2, the example interface transceiver 202 is configured to transmit the authorization token 119 to the database 210 to be stored. The interface transceiver 202 is configured to transmit the authorization token 119 to the response parser 204. In examples disclosed herein, the interface transceiver 202 is configured to, in response to an assignment being selected, transmit such assignment to the gateway shard 116 of FIG. 1. In some examples disclosed herein, the example interface transceiver 202 implements means for interfacing.

The example response parser 204 of FIG. 2 is implemented by a logic circuit such as, for example, a hardware processor. However, any other type of circuitry may additionally or alternatively be used such as, for example, one or more analog or digital circuit(s), logic circuits, programmable processor(s), application specific integrated circuit(s) (ASIC(s)), programmable logic device(s)(PLD(s)), field programmable logic device(s) (FPLD(s)), digital signal processor(s) (DSP(s)), etc. The response parser 204 is configured to parse the authorization token 119 to determine the tenant identification code previously created. In this manner, the response parser 204 is configured to communicate with the authorization network manager 118 to determine the corresponding PoP of the tenant (e.g., a user of the client device 102). In the event a PoP is not selected by the response parser 204, the shard selector 208 may select a shard within the current PoP capable of operating the selected SaaS. For example, if a user does not indicate a PoP, such a shard assignment selected by the shard selector 208 may be generated independent of a PoP preference.

In this manner, the response parser 204 is configured to determine the PoP selected by the user. In some examples disclosed herein, a user may indicate a plurality of selected SaaS and, as such, a plurality of corresponding PoPs associated with the plurality of SaaS. In such examples disclosed herein, the response parser 204 is configured to parse the one or more associated authorization tokens (e.g., the one or more authorization tokens provided in response to the plurality of selected SaaS requests, etc.) to determine the one or more PoPs. For example, a user may, via the onboarding reply 132, indicate a desire to utilize a first example SaaS in a first geographic region (e.g., Region 1 of FIG. 1) and a second selected SaaS in a second geographic region (e.g., Region 2 of FIG. 1). In this manner, the response parser 204 is configured to select the respective PoPs (e.g., Region 1 and Region 2) for use by the shard selector 208. In examples disclosed herein, the response parser 204 may store an indication representative of the one or more PoPs selected from the one or more authorization tokens(s) in the database 210. In some examples disclosed herein, the example response parser 204 implements means for parsing.

In the example illustrated in FIG. 2, the shard analyzer 206 is implemented by a logic circuit such as, for example, a hardware processor. However, any other type of circuitry may additionally or alternatively be used such as, for example, one or more analog or digital circuit(s), logic circuits, programmable processor(s), application specific integrated circuit(s)(ASIC(s)), programmable logic device(s)(PLD(s)), field programmable logic device(s) (FPLD(s)), digital signal processor(s) (DSP(s)), etc. The shard analyzer 206 is configured to communicate and/or otherwise analyze any of the first shard 110, the second shard 112, the third shard 114, the gateway shard 116, the authorization network manager 118, the fifth shard 122, the sixth shard 124, and/or the second gateway shard 126 of FIG. 1 to determine the associated weight. For example, the shard analyzer 206 may analyze the labels 134, 138, 142, 146, 150, 154, 158, and/or 162 to determine the corresponding weight of the respective shards. Furthermore, the shard analyzer 206 is configured to analyze the labels 134, 138, 142, 146, 150, 154, 158, and/or 162 to select the corresponding PoPs in which the respective shards are located in. Such information (e.g., the weights and/or the PoPs) may be stored in the database 210 for use by, at least, the shard selector 208. In some examples disclosed herein, the example shard analyzer 206 implements means for determining.

The example shard selector 208 of FIG. 2 is implemented by a logic circuit such as, for example, a hardware processor. However, any other type of circuitry may additionally or alternatively be used such as, for example, one or more analog or digital circuit(s), logic circuits, programmable processor(s), application specific integrated circuit(s) (ASIC(s)), programmable logic device(s)(PLD(s)), field programmable logic device(s) (FPLD(s)), digital signal processor(s) (DSP(s)), etc. In FIG. 2, the shard selector 208 obtains the user specified PoP and SaaS from the database 210 along with the corresponding PoP and weights of the first shard 110, the second shard 112, the third shard 114, the gateway shard 116, the authorization network manager 118, the fifth shard 122, the sixth shard 124, and/or the second gateway shard 126 of FIG. 1 obtained by the shard analyzer 206 and stored in the database 210. In examples disclosed herein, the shard selector 208 is configured to select a shard for assignment. For example, the shard selector 208 is configured to select an available shard associated with an equivalent PoP as the user specified PoP, along with a shard that has a suitable weight to handle the user request (e.g., the weight of the shard satisfies a weight threshold). In such a manner, a user request (e.g., a user request to utilize a SaaS provided in the onboarding reply 132 of FIG. 1) is associated with a shard located in the selected PoP and capable of operating the selected SaaS. In examples disclosed herein, the shard selector 208 is configured to determine whether the SaaS indicated in the onboarding reply 132 is equivalent to the SaaS associated with the shard. Furthermore, in such a manner, the shard selector 208 is configured to assign and/or otherwise determine an assignment for the user based on the onboarding reply 132. In examples disclosed herein, an assignment record indicated of the determined assignment is stored in the database 210 and communicated to the interface transceiver 202. In some examples disclosed herein, the example shard selector 208 implements means for assigning.

The example database 210 of the illustrated example of FIG. 2 may be implemented by any device for storing data such as, for example, a cloud memory disk and/or device, a flash memory disk and/or device, a magnetic media disk and/or device, an optical media disk and/or device, etc. Furthermore, the data stored in the example database 210 may be in any data format such as, for example, binary data, comma delimited data, tab delimited data, structured query language (SQL) structures, etc. The database 210 of FIG. 2 is configured to store the authorization token 119 obtained by the interface transceiver 202, the selected PoP and/or selected SaaS parsed by the response parser 204, the corresponding PoPs and/or weights determined by the shard analyzer 206, and/or the assignment selected by the shard selector 208. In some examples disclosed herein, the example database 210 implements means for storing.

While an example manner of implementing the cloud network 104 and/or the service network manager 120 of FIG. 1 is illustrated in FIG. 2, one or more of the elements, processes and/or devices illustrated in FIG. 2 may be combined, divided, re-arranged, omitted, eliminated and/or implemented in any other way. Further, the example first shard 110, the example second shard 112, the example third shard 114, the example gateway shard 116, the example authorization network manager 118, the example service network manager 120, the example fifth shard 122, the example sixth shard 124, the example second gateway shard 126, and/or, more generally, the example cloud network 104 of FIG. 1, and/or the example interface transceiver 202, the example response parser 204, the example shard analyzer 206, the example shard selector 208, the example database 210, and/or, more generally, the example service network manager 120 of FIGS. 1 and/or 2 may be implemented by hardware, software, firmware and/or any combination of hardware, software and/or firmware. Thus, for example, any of the example first shard 110, the example second shard 112, the example third shard 114, the example gateway shard 116, the example authorization network manager 118, the example service network manager 120, the example fifth shard 122, the example sixth shard 124, the example second gateway shard 126, and/or, more generally, the example cloud network 104 of FIG. 1, and/or the example interface transceiver 202, the example response parser 204, the example shard analyzer 206, the example shard selector 208, the example database 210, and/or, more generally, the example service network manager 120 of FIGS. 1 and/or 2 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s)(PLD(s)) and/or field programmable logic device(s)(FPLD(s)). When reading any of the apparatus or system claims of this patent to cover a purely software and/or firmware implementation, at least one of the example first shard 110, the example second shard 112, the example third shard 114, the example gateway shard 116, the example authorization network manager 118, the example service network manager 120, the example fifth shard 122, the example sixth shard 124, the example second gateway shard 126, and/or, more generally, the example cloud network 104 of FIG. 1, and/or the example interface transceiver 202, the example response parser 204, the example shard analyzer 206, the example shard selector 208, the example database 210, and/or, more generally, the example service network manager 120 of FIGS. 1 and/or 2 is/are hereby expressly defined to include a non-transitory computer readable storage device or storage disk such as a memory, a digital versatile disk (DVD), a compact disk (CD), a Blu-ray disk, etc. including the software and/or firmware. Further still, the example cloud network 104 of FIG. 1 and/or service network manager 120 of FIGS. 1 and/or 2 may include one or more elements, processes and/or devices in addition to, or instead of, those illustrated in FIGS. 1 and/or 2, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

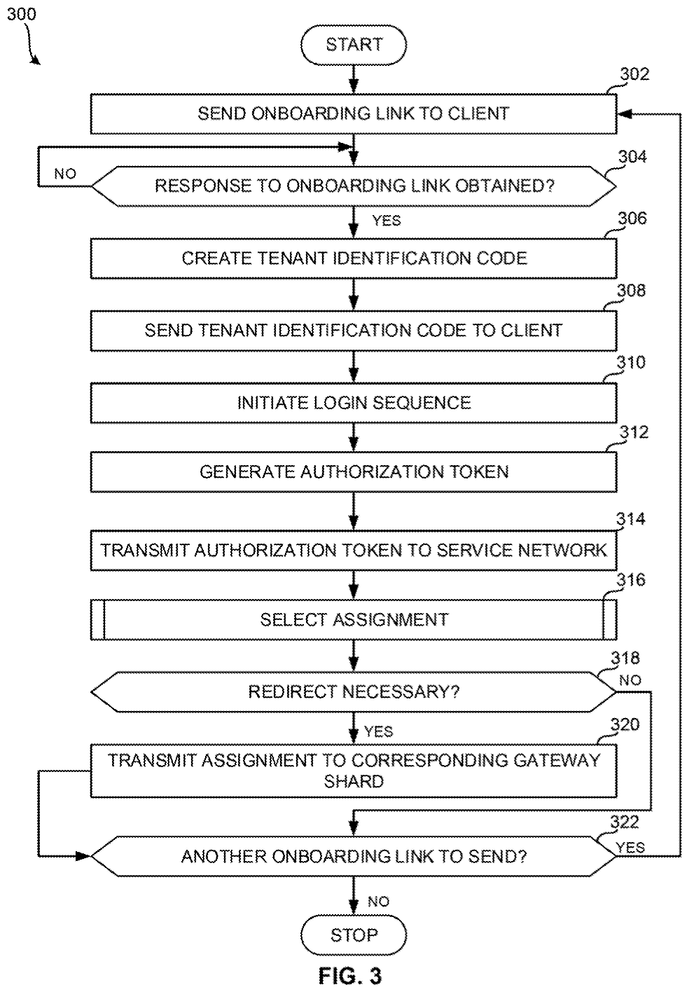

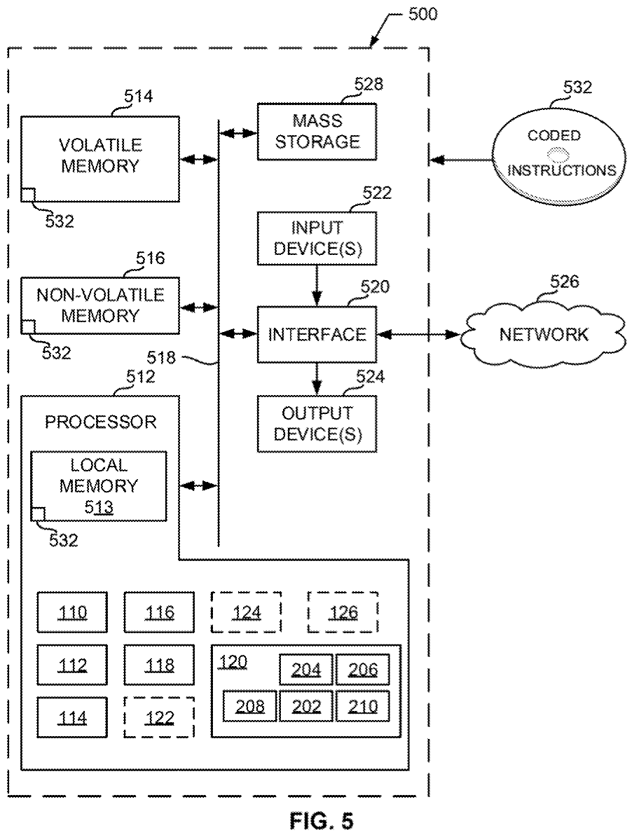

Flowcharts representative of example hardware logic, machine readable instructions, hardware implemented state machines, and/or any combination thereof for implementing the example cloud network 104 of FIG. 1 and/or the example service network manager 120 of FIGS. 1 and/or 2 are shown in FIGS. 3 and/or 4. The machine readable instructions may be one or more executable programs or portion(s) of an executable program for execution by a computer processor such as the processor 512 shown in the example processor platform 500 discussed below in connection with FIG. 5. The program may be embodied in software stored on a non-transitory computer readable storage medium such as a CD-ROM, a floppy disk, a hard drive, a DVD, a Blu-ray disk, or a memory associated with the processor 512, but the entire program and/or parts thereof could alternatively be executed by a device other than the processor 512 and/or embodied in firmware or dedicated hardware. Further, although the example program is described with reference to the flowchart illustrated in FIGS. 3 and/or 4, many other methods of implementing the example cloud network 104 and/or the example service network manager 120 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

The machine readable instructions described herein may be stored in one or more of a compressed format, an encrypted format, a fragmented format, a compiled format, an executable format, a packaged format, etc. Machine readable instructions as described herein may be stored as data (e.g., portions of instructions, code, representations of code, etc.) that may be utilized to create, manufacture, and/or produce machine executable instructions. For example, the machine readable instructions may be fragmented and stored on one or more storage devices and/or computing devices (e.g., servers). The machine readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine readable instructions may be stored in multiple parts, which are individually compressed, encrypted, and stored on separate computing devices, wherein the parts when decrypted, decompressed, and combined form a set of executable instructions that implement a program such as that described herein.

In another example, the machine readable instructions may be stored in a state in which they may be read by a computer, but require addition of a library (e.g., a dynamic link library (DLL)), a software development kit (SDK), an application programming interface (API), etc. in order to execute the instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, the disclosed machine readable instructions and/or corresponding program(s) are intended to encompass such machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example processes of FIGS. 3 and/or 4 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without failing outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (l) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first” “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

FIG. 3 is a flowchart representative of example machine readable instructions 300 which may be executed to implement the cloud network 104 of FIG. 1 to onboard the client device 102 of FIG. 1. In the example of FIG. 3, the authorization network manager 118 of FIG. 1 sends the example onboarding link 130 (FIG. 1) to the client device 102 of FIG. 1. (Block 302). In some examples disclosed herein, the control of block 302 may be responsive to an onboarding request (e.g., the onboarding request 129 of FIG. 1) being obtained via the gateway shard 16.

The authorization network manager 118 determines whether a response to the onboarding link 130 (e.g., the example onboarding reply 132 of FIG. 1) is obtained. (Block 304). In response to the authorization network manager 118 determining the response to the onboarding link 130 (e.g., the onboarding reply 132) is not obtained (e.g., the control of block 304 returns a result of NO), control proceeds to wait. In some examples disclosed herein, control may stop in response to a time-out event occurring if control waits for more than a threshold period of time.

Alternatively, in response to the authorization network manager 118 determining the response to the onboarding link 130 (e.g., the onboarding reply 132) is obtained (e.g., the control of block 304 returns a result of YES), the example authorization network manager 118 of FIG. 1 creates a tenant identification code for the user. (Block 306). In addition, the authorization network manager 118 sends the tenant identification code to the client device 102. (Block 308). Furthermore, in series and/or in parallel, the authorization network manager 118 initiates a login sequence. (Block 310). In response to execution of a successful login sequence, the authorization network manager 118 generates an example authorization token 119. (Block 312). Furthermore, the gateway shard 116 transmits the authorization token 119 to the example service network manager 120 of FIGS. 1 and/or 2. (Block 314). In examples disclosed herein, the gateway shard 116 may transmit the authorization token 119 to the service network manager 120 via an API hosted by the gateway shard 116 configured to provide access to the service network manager 120.

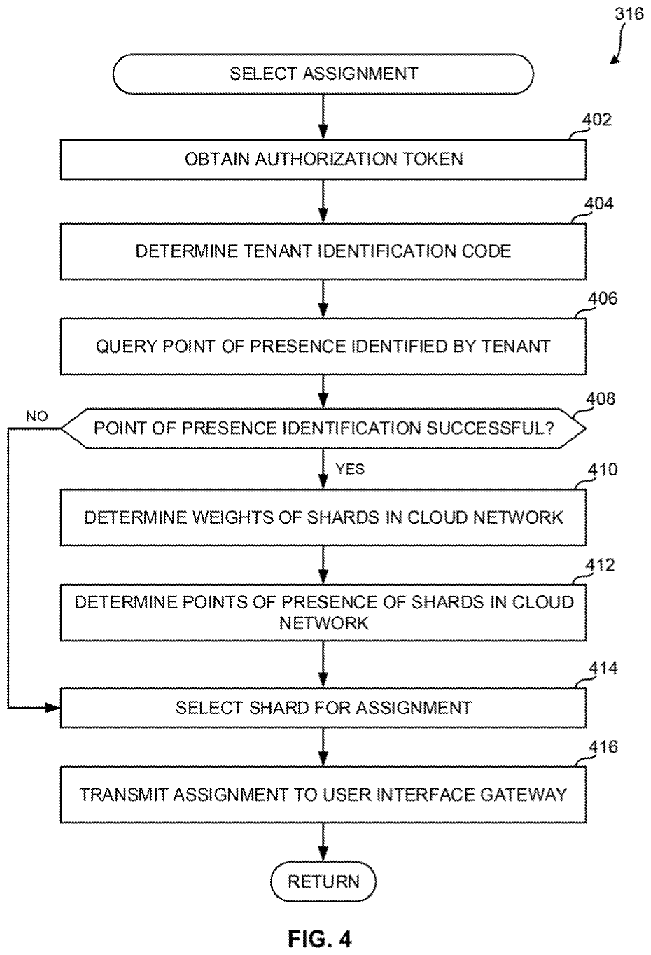

The service network manager 120 is configured to determine the assignment for the authorization token 119. (Block 316). The control of block 316 is explained in further detail below, in connection with FIG. 4.

In the example of FIG. 3, the gateway shard 116 is configured to determine whether a redirect is necessary. (Block 318). If the gateway shard 116 determines a redirect is necessary (e.g., the control of block 318 returns a result of YES), then the gateway shard 116 transmits and/or otherwise redirects such an assignment to the gateway shard (e.g., the second gateway shard 126 of FIG. 1) in the corresponding PoP. (Block 320). In examples disclosed herein, the gateway shard 116 may determine a redirect is necessary when the assignment corresponds to a PoP different than the PoP in which the gateway shard 116 is located in. In response to the execution of the control illustrated in block 320, or alternatively, if the gateway shard 116 determines a redirect is not necessary (e.g., the control of block 318 returns a result of NO), control proceeds to block 322 in which the gateway shard 116 determines whether there is another onboarding link to send. (Block 322).

If the gateway shard 116 determines there is another onboarding link to send (e.g., the control of block 322 returns a result of YES), control returns to block 302. Alternatively, if the gateway shard 116 determines there is not another onboarding link to send (e.g., the control of block 322 returns a result of NO), control stops.

FIG. 4 is a flowchart representative of example machine readable instructions which may be executed to implement the service network manager 120 of FIGS. 1 and/or 2 to select an assignment. In the example illustrated in FIG. 4, the interface transceiver 202 of FIG. 2 obtains the example authorization token 119 from the gateway shard 116 of FIG. 1. (Block 402). The example response parser 204 of FIG. 2 determines the tenant identification code. (Block 404). For example, the response parser 204 parses the authorization token 119 obtained from the interface transceiver 202 to determine the tenant identification code. The response parser 204 queries the PoP selected by the tenant. (Block 406). As such, the response parser 204 determines whether the PoP identification is successful. (Block 408). In the event PoP identification is not successful (e.g., the control of block 408 returns a result of NO), control proceeds to block 414 in which the shard selector 208 selects a shard for assignment. PoP selection may be unsuccessful in the event a user does not specify a PoP in the onboarding request 129 and/or the onboarding reply 132.

If the response parser 204 determines the PoP identification is successful (e.g., the control of block 408 returns a result of YES and/or the response parser 204 successfully determines the PoP selected and/or identified by the tenant), the example shard analyzer 206 of FIG. 2 determines the corresponding weights of the respective shards located in the cloud network 104 of FIG. 1. (Block 410). The shard analyzer 206 further determines the corresponding PoPs of the associated shards located in the cloud network 104. (Block 412).

The example shard selector 208 selects a shard for assignment. (Block 414). For example, the shard selector 208 may select an available shard associated with the same PoP identified in block 408 as the user specified PoP selected in block 404, along with a shard that has a suitable weight to handle the user request. In such a manner, a user request (e.g., a user request to utilize a SaaS provided in the onboarding reply 132 of FIG. 1) is associated with a shard located in the selected PoP and capable of operating the selected SaaS. Further, the shard selector 208 may either assign the shard to the user, or assign the user to the shard when executing the control of block 414.

In response, the interface transceiver 202 transmits the assignment to an example user interface deployed as a shard (e.g., the gateway shard 116). (Block 416). Control of the instructions represented by FIG. 4 then return to a calling function or process such as one executed based on instructions represented by FIG. 3.

FIG. 5 is a block diagram of an example processor platform 500 structured to execute the instructions of FIGS. 3 and/or 4 to implement the example cloud network 104 of FIG. 1 and/or the example service network manager 120 of FIGS. 1 and/or 2. The processor platform 500 can be, for example, a server, a personal computer, a workstation, a self-learning machine (e.g., a neural network), a mobile device (e.g., a cell phone, a smart phone, a tablet such as an iPad), a personal digital assistant (PDA), an Internet appliance, a DVD player, a CD player, a digital video recorder, a Blu-ray player, a gaming console, a personal video recorder, a set top box, a headset or other wearable device, or any other type of computing device.

The processor platform 500 of the illustrated example includes a processor 512. The processor 512 of the illustrated example is hardware. For example, the processor 512 can be implemented by one or more integrated circuits, logic circuits, microprocessors, GPUs, DSPs, or controllers from any desired family or manufacturer. The hardware processor may be a semiconductor based (e.g., silicon based) device. In this example, the processor implements the example first shard 110, the example second shard 112, the example third shard 114, the example gateway shard 116, the example authorization network manager 118, the example service network manager 120, the example fifth shard 122, the example sixth shard 124, the example second gateway shard 126, and/or, more generally, the example cloud network 104 of FIG. 1, and/or the example interface transceiver 202, the example response parser 204, the example shard analyzer 206, the example shard selector 208, the example database 210, and/or, more generally, the example service network manager 120 of FIGS. 1 and/or 2. Alternatively, in other examples disclosed herein, the fifth shard 122, the sixth shard 124, and/or the second gateway shard 126 may be implemented on a separate processor platform operable in a similar manner as the processor platform 500.

The processor 512 of the illustrated example includes a local memory 513 (e.g., a cache). The processor 512 of the illustrated example is in communication with a main memory including a volatile memory 514 and a non-volatile memory 516 via a bus 518. The volatile memory 514 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 516 may be implemented by flash memory and/or any other desired type of memory device. Access to the main memory 514, 516 is controlled by a memory controller.

The processor platform 500 of the illustrated example also includes an interface circuit 520. The interface circuit 520 may be implemented by any type of interface standard, such as an Ethernet interface, a universal serial bus (USB), a Bluetooth® interface, a near field communication (NFC) interface, and/or a PCI express interface.

In the illustrated example, one or more input devices 522 are connected to the interface circuit 520. The input device(s) 522 permit(s) a user to enter data and/or commands into the processor 512. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 524 are also connected to the interface circuit 520 of the illustrated example. The output devices 524 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 520 of the illustrated example, thus, typically includes a graphics driver card, a graphics driver chip and/or a graphics driver processor.

The interface circuit 520 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 526. The communication can be via, for example, an Ethernet connection, a digital subscriber line (DSL) connection, a telephone line connection, a coaxial cable system, a satellite system, a line-of-site wireless system, a cellular telephone system, etc.

The processor platform 500 of the illustrated example also includes one or more mass storage devices 528 for storing software and/or data. Examples of such mass storage devices 528 include floppy disk drives, hard drive disks, compact disk drives, Blu-ray disk drives, redundant array of independent disks (RAID) systems, and digital versatile disk (DVD) drives.

Example machine executable instructions 532 represented by FIGS. 3 and/or 4 may be stored in the mass storage device 528, in the volatile memory 514, in the non-volatile memory 516, and/or on a removable non-transitory computer readable storage medium such as a CD or DVD.

From the foregoing, it will be appreciated that example methods, apparatus and articles of manufacture have been disclosed that improve performance of cloud-based services across geographic regions. Examples disclosed herein utilize infrastructure located in a plurality of geographic regions. In such a manner, if a user indicates a PoP of the United Kingdom and would like to utilize a service (e.g., a SaaS), then the user would be assigned a shard that is a deployed instance of the service (e.g., the SaaS) located in the same PoP (e.g., in the United Kingdom). In examples disclosed herein, a user's (e.g., a tenant's) data may not be persisted, utilized, stored, and/or otherwise accessed outside the indicated PoP. The disclosed methods, apparatus, and articles of manufacture may be useful to comply with data privacy laws of different governments. For example, the disclosed methods, apparatus, and articles of manufacture may be useful to comply with the General Data Protection Regulation (GDPR) of Europe which

Examples disclosed herein improve performance when accessing and/or otherwise utilizing a service (e.g., a SaaS). The disclosed methods, apparatus and articles of manufacture improve the efficiency of using a computing device by enabling a user in a first region to utilize the SaaS hosted on an infrastructure located in a second region while maintaining a similar performance experience as users in the second region. The disclosed methods, apparatus and articles of manufacture are accordingly directed to one or more improvement(s) in the functioning of a computer.

Example methods, apparatus, systems, and articles of manufacture to improve performance of cloud-based services across geographic regions are disclosed herein. Further examples and combinations thereof include the following:

Example 1 includes an apparatus comprising a response parser to in response to obtaining an authorization token indicating to utilize a software-as-a-service (SaaS), determine a tenant identification code based on an authorization token, and determine a first point of presence in response to determining the tenant identification code, a shard analyzer to determine a second point of presence of a shard, the shard being a deployed instance of the SaaS, and a shard selector to assign the shard to a user when the first point of presence and the second point of presence are the same.

Example 2 includes the apparatus of example 1, wherein the shard analyzer is to analyze a second shard to determine a third point of presence, the second shard being a second deployed instance of the SaaS, the third point of presence different than the second point of presence.

Example 3 includes the apparatus of example 2, wherein the shard selector is to assign the second shard to the user when the first point of presence and the third point of presence are the same.

Example 4 includes the apparatus of example 3, further including a first gateway located in the first point of presence to transmit an indication of the assigned shard to a second gateway located in the third point of presence.

Example 5 includes the apparatus of example 1, wherein the response parser, the shard analyzer, and the shard selector are located in a third point of presence, the first point of presence and the second point of presence are the same and different than the third point of presence.

Example 6 includes the apparatus of example 1, further including an interface transceiver to transmit an indication of the assigned shard to a gateway, the gateway located in a third point of presence and, when the third point of presence is different than (1) the first point of presence and (2) the second point of presence, transmit the indication of the assigned shard to a second gateway located in (1) the first point of presence and (2) the second point of presence.

Example 7 includes the apparatus of example 1, wherein the shard selector is to determine a weight of the shard, and assign the shard to the user when the weight satisfies a weight threshold.

Example 8 includes the apparatus of example 1, wherein the response parser is to parse the authorization token to determine the tenant identification code.

Example 9 includes a non-transitory computer readable medium comprising instructions which, when executed, cause at least one processor to at least in response to obtaining an authorization token indicating to utilize a software-as-a-service (SaaS), determine a tenant identification code based on an authorization token, determine a first point of presence in response to determining the tenant identification code, determine a second point of presence of a shard, the shard being a deployed instance of the SaaS, and assign the shard to a user when the first point of presence and the second point of presence are the same.

Example 10 includes the non-transitory computer readable medium of example 9, wherein the instructions, when executed, further cause the at least one processor to analyze a second shard to determine a third point of presence, the second shard being a second deployed instance of the SaaS, the third point of presence different than the second point of presence.

Example 11 includes the non-transitory computer readable medium of example 10, wherein the instructions, when executed, further cause the at least one processor to assign the second shard to the user when the first point of presence and the third point of presence are the same.

Example 12 includes the non-transitory computer readable medium of example 9, wherein the instructions, when executed, further cause the at least one processor to transmit an indication of the assigned shard to a gateway, the gateway located in a third point of presence, and when the third point of presence is different than (1) the first point of presence and (2) the second point of presence, transmit the indication of the assigned shard to a second gateway located in (1) the first point of presence and (2) the second point of presence.

Example 13 includes the non-transitory computer readable medium of example 9, wherein the instructions, when executed, further cause the at least one processor to determine a weight of the shard, and assign the shard to the user when the weight satisfies a weight threshold.

Example 14 includes the non-transitory computer readable medium of example 9, wherein the instructions, when executed, further cause the at least one processor to parse the authorization token to determine the tenant identification code.

Example 15 includes a method comprising in response to obtaining an authorization token indicating to utilize a software-as-a-service (SaaS), determining a tenant identification code based on an authorization token, determining a first point of presence in response to determining the tenant identification code, determining a second point of presence of a shard, the shard being a deployed instance of the SaaS, and assigning the shard to a user when the first point of presence and the second point of presence are the same.

Example 16 includes the method of example 15, further including analyzing a second shard to determine a third point of presence, the second shard being a second deployed instance of the SaaS, the third point of presence different than the second point of presence.

Example 17 includes the method of example 16, further including assigning the second shard to the user when the first point of presence and the third point of presence are the same.

Example 18 includes the method of example 15, further including transmitting an indication of the assigned shard to a gateway, the gateway located in a third point of presence, and when the third point of presence is different than (1) the first point of presence and (2) the second point of presence, transmitting the indication of the assigned shard to a second gateway located in (1) the first point of presence and (2) the second point of presence.

Example 19 includes the method of example 15, further including determining a weight of the shard, and assigning the shard to the user when the weight satisfies a weight threshold.

Example 20 includes the method of example 15, further including parsing the authorization token to determine the tenant identification code.

Example 21 includes an apparatus comprising means for parsing to in response to obtaining an authorization token indicating to utilize a software-as-a-service (SaaS), determine a tenant identification code based on an authorization token, and determine a first point of presence in response to determining the tenant identification code, means for determining a second point of presence of a shard, the shard being a deployed instance of the SaaS, and means for assigning the shard to a user when the first point of presence and the second point of presence are the same.

Example 22 includes the apparatus of example 21, wherein the analyzing means is to analyze a second shard to determine a third point of presence, the second shard being a second deployed instance of the SaaS, the third point of presence different than the second point of presence.

Example 23 includes the apparatus of example 22, wherein the assigning means is to assign the second shard to the user when the first point of presence and the third point of presence are the same.

Example 24 includes the apparatus of example 21, further including means for interfacing to transmit an indication of the assigned shard to a means for transmitting, the means for transmitting located in a third point of presence, and when the third point of presence is different than (1) the first point of presence and (2) the second point of presence, transmit the indication of the assigned shard to a second means for transmitting located in (1) the first point of presence and (2) the second point of presence.

Example 25 includes the apparatus of example 21, wherein the assigning means is to determine a weight of the shard, and assign the shard to the user when the weight satisfies a weight threshold.

Example 26 includes the apparatus of example 21, wherein the parsing means is to parse the authorization token to determine the tenant identification code.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. An apparatus comprising:
a response parser to:
in response to obtaining an authorization token indicating to utilize a software-as-a-service (SaaS), determine a tenant identification code based on an authorization token; and
determine a first point of presence in response to determining the tenant identification code;
a shard analyzer to determine a second point of presence of a shard, the shard being a deployed instance of the SaaS; and
a shard selector to assign the shard to a user when the first point of presence and the second point of presence are the same.

2. The apparatus of claim 1, wherein the shard analyzer is to analyze a second shard to determine a third point of presence, the second shard being a second deployed instance of the SaaS, the third point of presence different than the second point of presence.

3. The apparatus of claim 2, wherein the shard selector is to assign the second shard to the user when the first point of presence and the third point of presence are the same.

4. The apparatus of claim 3, further including a first gateway located in the first point of presence to transmit an indication of the assigned shard to a second gateway located in the third point of presence.

5. The apparatus of claim 1, wherein the response parser, the shard analyzer, and the shard selector are located in a third point of presence, the first point of presence and the second point of presence are the same and different than the third point of presence.

6. The apparatus of claim 1, further including an interface transceiver to:
transmit an indication of the assigned shard to a gateway, the gateway located in a third point of presence; and
when the third point of presence is different than (1) the first point of presence and (2) the second point of presence, transmit the indication of the assigned shard to a second gateway located in (1) the first point of presence and (2) the second point of presence.

7. The apparatus of claim 1, wherein the shard selector is to:
determine a weight of the shard; and
assign the shard to the user when the weight satisfies a weight threshold.

8. The apparatus of claim 1, wherein the response parser is to parse the authorization token to determine the tenant identification code.

9. A non-transitory computer readable medium comprising instructions which, when executed, cause at least one processor to at least:
in response to obtaining an authorization token indicating to utilize a software-as-a-service (SaaS), determine a tenant identification code based on an authorization token;
determine a first point of presence in response to determining the tenant identification code;
determine a second point of presence of a shard, the shard being a deployed instance of the SaaS; and
assign the shard to a user when the first point of presence and the second point of presence are the same.

10. The non-transitory computer readable medium of claim 9, wherein the instructions, when executed, further cause the at least one processor to analyze a second shard to determine a third point of presence, the second shard being a second deployed instance of the SaaS, the third point of presence different than the second point of presence.

11. The non-transitory computer readable medium of claim 10, wherein the instructions, when executed, further cause the at least one processor to assign the second shard to the user when the first point of presence and the third point of presence are the same.

12. The non-transitory computer readable medium of claim 9, wherein the instructions, when executed, further cause the at least one processor to:
transmit an indication of the assigned shard to a gateway, the gateway located in a third point of presence; and
when the third point of presence is different than (1) the first point of presence and (2) the second point of presence, transmit the indication of the assigned shard to a second gateway located in (1) the first point of presence and (2) the second point of presence.

13. The non-transitory computer readable medium of claim 9, wherein the instructions, when executed, further cause the at least one processor to:
determine a weight of the shard; and
assign the shard to the user when the weight satisfies a weight threshold.

14. The non-transitory computer readable medium of claim 9, wherein the instructions, when executed, further cause the at least one processor to parse the authorization token to determine the tenant identification code.

15. A method comprising:
in response to obtaining an authorization token indicating to utilize a software-as-a-service (SaaS), determining a tenant identification code based on an authorization token;
determining a first point of presence in response to determining the tenant identification code;
determining a second point of presence of a shard, the shard being a deployed instance of the SaaS; and
assigning the shard to a user when the first point of presence and the second point of presence are the same.

16. The method of claim 15, further including analyzing a second shard to determine a third point of presence, the second shard being a second deployed instance of the SaaS, the third point of presence different than the second point of presence.

17. The method of claim 16, further including assigning the second shard to the user when the first point of presence and the third point of presence are the same.

18. The method of claim 15, further including:
transmitting an indication of the assigned shard to a gateway, the gateway located in a third point of presence; and
when the third point of presence is different than (1) the first point of presence and (2) the second point of presence, transmitting the indication of the assigned shard to a second gateway located in (1) the first point of presence and (2) the second point of presence.

19. The method of claim 15, further including:
determining a weight of the shard; and
assigning the shard to the user when the weight satisfies a weight threshold.

20. The method of claim 15, further including parsing the authorization token to determine the tenant identification code.

21. An apparatus comprising:
means for parsing to:
in response to obtaining an authorization token indicating to utilize a software-as-a-service (SaaS), determine a tenant identification code based on an authorization token; and
determine a first point of presence in response to determining the tenant identification code;
means for determining a second point of presence of a shard, the shard being a deployed instance of the SaaS; and
means for assigning the shard to a user when the first point of presence and the second point of presence are the same.

22. The apparatus of claim 21, wherein the analyzing means is to analyze a second shard to determine a third point of presence, the second shard being a second deployed instance of the SaaS, the third point of presence different than the second point of presence.

23. The apparatus of claim 22, wherein the assigning means is to assign the second shard to the user when the first point of presence and the third point of presence are the same.

24. The apparatus of claim 21, further including means for interfacing to:
transmit an indication of the assigned shard to a means for transmitting, the means for transmitting located in a third point of presence; and
when the third point of presence is different than (1) the first point of presence and (2) the second point of presence, transmit the indication of the assigned shard to a second means for transmitting located in (1) the first point of presence and (2) the second point of presence.

25. The apparatus of claim 21, wherein the assigning means is to:
determine a weight of the shard; and
assign the shard to the user when the weight satisfies a weight threshold.

26. The apparatus of claim 21, wherein the parsing means is to parse the authorization token to determine the tenant identification code.
